(19) United States
(12) Patent Application Publication
(10) Pub. No.: US 2026/0140748 A1
(43) Pub. Date: May 21, 2026

(54) WINDOW DISPLAY METHOD, APPARATUS, TERMINAL AND STORAGE MEDIUM

(71) Applicant: BEIJING BYTEDANCE NETWORK TECHNOLOGY CO., LTD., Beijing (CN)

(72) Inventor: Yanyun GONG, Beijing (CN)

(21) Appl. No.: 19/452,105

(22) Filed: Jan. 16, 2026

Related U.S. Application Data
(63) Continuation of application No. 17/768,838.

(30) Foreign Application Priority Data
Oct. 14, 2019 (CN) 201910974122.3

(51) Int. Cl. G06F 9/451; G06F 3/0481

(52) U.S. Cl. CPC G06F 9/451; G06F 3/0481

(57) ABSTRACT

A window display method and apparatus, and a terminal and a storage medium. The method comprises: displaying a window of an application installed in a terminal device, wherein the window of the application is divided into a title display region and a page display region, wherein the title display region includes a plurality of titles, the plurality of titles include a first title, and wherein the page display region includes a first page corresponding to the first title; in response to a sliding event performed on the page display region in a first direction, moving the first page in the first direction by a first distance to display a second page corresponding to a second title, and moving the first title in the first direction by a second distance, wherein a ratio of the first distance to the second distance is determined based on a width of the first page in the first direction and a width of the first title in the first direction; detecting that the first title is partially displayed or positioned outside a visible region of the title display region after moving the first title by the second distance; and in response to the detecting, automatically moving the first title so that the first title is completely visible within the title display region.

### CROSS-REFERENCE TO RELATED APPLICATIONS

The present application is a continuation of U.S. patent application Ser. No. 17/768,838, filed on Apr. 13, 2022, which is a national phase application of International Application No. PCT/CN2020/114798, filed on Sep. 11, 2020, which claims the priority to Chinese Patent Application No.201910974122.3, titled “WINDOW DISPLAY METHOD, APPARATUS, TERMINAL AND STORAGE MEDIUM”, filed on Oct. 14, 2019 with the Chinese Patent Office, which are incorporated herein by reference in their entireties.

### FIELD

The present disclosure relates to the technical field of computers, and in particular to a window display method, a window display apparatus, a terminal and a storage medium.

### BACKGROUND

According to the conventional window display method, the user can only view a title by sliding a title display bar or a title display region, and then clicks the title to view a corresponding page. However, the user experience of page interaction is not ideal.

### SUMMARY

The content part of the present disclosure is provided to introduce concepts in a brief form, and these concepts are to be described in detail in the following embodiments. The content of the present disclosure is not intended to identify the key features or essential features of the claimed technical solutions, nor is it intended to be used to limit the scope of the claimed technical solutions.

To solve the above problems, a window display method, a window display apparatus, a terminal and a storage medium are provided according to the present disclosure. With the window display method according to the present disclosure, linkage between a title display region and a page display region can be realized, facilitating viewing a page by the user, and thereby improving the user experience.

According to an embodiment of the present disclosure, a window display method is provided. The method includes: displaying an application window, where the application window includes a title display region and a page display region, and the title display region includes a title corresponding to a page displayed in the page display region; and in response to an operation event performed in the page display region or in the title display region, moving the page in the page display region by a first distance and moving the title in the title display region by a second distance. As one of the page and the title is moved, the other one of the page and the title is also moved, and the first distance is different from the second distance.

According to another embodiment of the present disclosure, a window display method is provided. The method includes: displaying an application window, where the application window includes a title display region and a page display region, the title display region includes a first title and a second title, the first title corresponds to a page displayed in the page display region, the first title has a first brightness, the second title has a second brightness, and the first brightness is greater than the second brightness; and in response to an operation event performed in the page display region, moving the page in the page display region by a distance without moving the first title and the second title. After the page is moved by the distance, the page display region displays a page corresponding to the second title, brightness of the first title is changed from the first brightness to the second brightness, and brightness of the second title is changed from the second brightness to the first brightness.

According to another embodiment of the present disclosure, a window display apparatus is provided. The apparatus includes: an application window display module and a control module. The application window display module is configured to display an application window, where the application window includes a title display region and a page display region, and the title display region includes a title corresponding to a page displayed in the page display region. The control module is configured to, in response to an operation event performed in the page display region or in the title display region, move the page in the page display region by a first distance and move the title in the title display region by a second distance. As one of the page and the title is moved, the other one of the page and the title is also moved, and the first distance is different from the second distance.

According to another embodiment of the present disclosure, a terminal is provided. The terminal includes: at least one memory and at least one processor. The memory stores program codes. The processor is configured to perform, when executing the program codes stored in the memory, any one of the window display methods described above.

According to another embodiment of the present disclosure, a computer storage medium is provided. The computer storage medium stores program codes. The program codes are executed to perform any of the window display methods described above.

With the window display method according to the present disclosure, the user can easily view a page, improving convenience of page interaction, and thereby improving the user experience.

### BRIEF DESCRIPTION OF THE DRAWINGS

The above and other features, advantages and aspects of the embodiments of the present disclosure will be more apparent in conjunction with the accompanying drawings and with reference to the following embodiments. Throughout the drawings, the same or similar reference numerals represent the same or similar elements. It should be understood that the drawings are schematic and the originals and elements are unnecessarily drawn to scale.

FIG. 1 shows a flow chart of a window display method according to an embodiment of the present disclosure;

FIGS. 2 and 3 show schematic diagrams of window display according to embodiments of the present disclosure;

FIG. 4 shows a schematic diagram of a window display apparatus according to an embodiment of the present disclosure; and

FIG. 5 shows a schematic structural diagram of an electronic device 500 suitable for implementing the embodiments of the present disclosure.

### DETAILED DESCRIPTION OF THE EMBODIMENTS

The embodiments of the present disclosure are described in detail below with reference to the accompanying drawings. Although the drawings show some embodiments of the present disclosure, it should be understood that the present disclosure can be implemented in various forms and is not limited to the embodiments. The embodiments are provided for a more thorough and complete understanding of the present disclosure. It should be understood that the drawings and the embodiments in the present disclosure are only illustrative of the disclosure, and are not intended to limit the protection scope of the present disclosure.

It should be understood that the steps of the method according to the embodiments of the present disclosure may be performed in different orders, and/or be performed in parallel. In addition, the method embodiments may include additional steps and/or omit to perform the illustrated steps, not limiting the scope of the present disclosure.

The term “including” and its variants as used herein are open-ended includes, that is, “including but not limited to”. The term “based on” means “based at least in part on.” The term “one embodiment” means “at least one embodiment”. The term “another embodiment” means “at least one additional embodiment”. The term “some embodiments” means “at least some embodiments”. Definitions of other terms are provided in the following description.

It should be noted that, the terms “first’” “second” and so on mentioned in the present disclosure are only used to distinguishing different apparatuses, modules or units, rather than limit an order of functions performed by the apparatus, module or unit or limit interdependence.

It should be noted that, the terms “one” and “multiple” mentioned in the present disclosure are schematic rather than restrictive, and should be understood as “one or more” by those skilled in the art, otherwise explicitly illustrated in the context.

According to the conventional window display method, the user can only switch pages by clicking on a title, so that the experience of page interaction is not ideal.

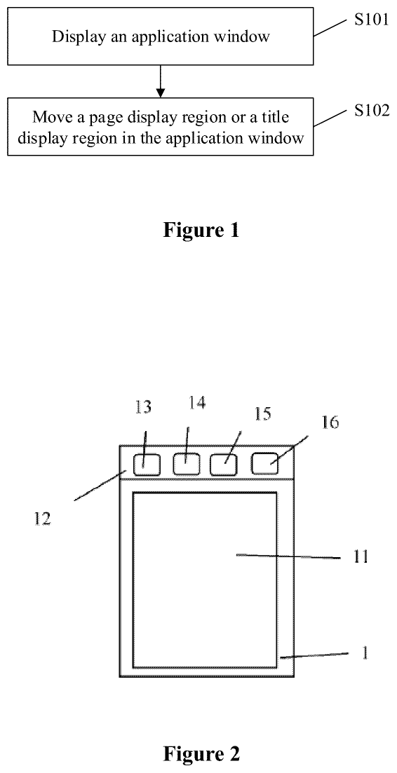

To further improve the user experience of page interaction, as shown in FIGS. 1 and 2, a window display method is provided according to the present disclosure. The method includes a step S101. In step S101, an application window 1 is displayed. The application window 1 includes a page display region 11 and a title display region 12. In some embodiments, the “window” in the window display method refers to windows of various App applications installed in a terminal. The terminal in the present disclosure may include, but is not limited to, a mobile terminal device such as a mobile phone, a smart phone, a notebook computer, a PDA (personal digital assistant), a PAD (tablet PC), a PMP (portable multimedia player), a navigation device, a vehicle-mounted terminal device, a vehicle-mounted display terminal and a vehicle-mounted electronic rearview mirror, and a fixed terminal device such as a digital TV and a desktop computer.

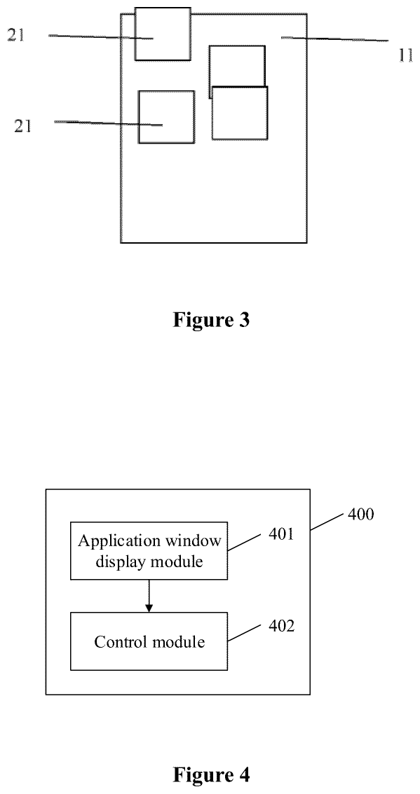

In some embodiments, the page display region 11 may display various page information, such as a song list and a product list. As shown in FIG. 3, page information displayed in the page display region 11 is schematically shown in box 21. It should be understood that FIG. 3 is schematic, and the number of pieces of information displayed in the page display region 11 may be more or less than four. In addition, outside a current page display region, there may be an information bar that has not been displayed in the current page display region. For example, when the page display region 11 is slid up and down, an information bar that has not been displayed in the page display region 11 may be seen.

In some embodiments, as shown in FIG. 2, a title display region 12 may display various titles or buttons, such as 13, 14, 15 and 16. The titles may include images, text, or text and images. In some embodiments, a page display region 11 displays a page corresponding to one of the titles (such as 13, 14, 15, and 16) displayed in the title display region 12. It should be understood that the titles shown in FIG. 2 are schematic and the number of the titles displayed in the title display region 12 may be more or less than four. In addition, outside a current title display region, there may be a title that has not been displayed in the current title display region. For example, when a title in the title display region 12 is slid horizontally, a title that has not been displayed in the title display region 12 may be seen.

In addition, although the title display region 12 shown in FIG. 2 is above the page display region 11, the present disclosure is not limited thereto. The title display region 12 may be located below, on a left side or a right side of the page display region 11. In addition, the titles in the title display region 12 are not limited to be arranged horizontally, and may be arranged vertically on the left side or right side of the screen.

The window display method according to the present disclosure further includes a step S102. In step S102, in response to an operation event performed in the page display region 11 or in the title display region 12, the page displayed in the page display region 11 is moved by a first distance, and the title in the title display region 12 is moved by a second distance. In some embodiments, since a width of a page displayed in the page display region 11 is different from a width of a title corresponding to the page and displayed in the title display region 12, the first distance is usually different from the second distance. Generally, the width of the page is greater than the width of the title corresponding to the page, so that the first distance is generally greater than the second distance. In some embodiments, the width described in the present disclosure generally refers to a width of a title in an arrangement direction in the title display region 12.

In some embodiments, the operation event is an operation for sliding a page in the page display region 11 or sliding a title in the title display region 12, including but not limited to a touch screen sliding, a voice command or a gesture operation. In some embodiments, pages may be switched by sliding the page display region 11 or the title display region 12 in a horizontal direction or in a lateral direction of the screen of the terminal. However, the present disclosure is not limited thereto. Pages may be switched by arranging the titles in the title display region 12 vertically or longitudinally and then sliding the page display region 11 or the title display region 12 in a vertical direction or in a longitudinal direction of the screen of the terminal.

In some embodiments, the page in the page display region 11 is moved in the first direction by the first distance, the title in the title display region 12 is moved in the first direction by the second distance, the page in the page display region 11 has a first width in the first direction, and the title, corresponding to the page, in the title display region 12 has a second width in the first direction. In some embodiments, as shown in FIG. 2, if the titles in the title display region 12 are arranged in a horizontal direction or in a lateral direction, the first direction is the horizontal direction or the lateral direction. However, the present disclosure is not limited thereto. In some embodiments, the page in the page display region 11 and the title corresponding to the page are linked, that is, as one of the page and the corresponding title is moved, the other one of the page and the corresponding title is also moved. In some embodiments, in order to keep the page displayed in the page display region 11 synchronized or linked with the corresponding title displayed in the title display region 12, a ratio of the first width to the second width is equal to a ratio of the first distance to the second distance. For example, as shown in FIG. 2, assuming that the page displayed in the page display region 11 corresponds to the title 14, a sliding operation is performed on the page display region 11 (for example, sliding to a left direction), so that the page displayed in the page display region 11 corresponds to the title 15. Thus, the title 15 may be moved to the position of the title 14. That is, in a case that the page display region 11 is moved by a size or a distance of one page, the title display region 12 is moved by a width of a title corresponding to the page (for example, the title display region 12 is moved by a distance corresponding to the width of the title 14).

Similarly, in a case that the title display region 12 is moved, for example, by a width of two titles, the title 16 is moved to the position of the title 14. Then, the page displayed in the page display region 11 corresponds to the title 16, that is, the page display region 11 is moved by a distance of two pages. It should be understood that for the aesthetics of the window display, the widths of all the titles are usually the same. However, the method according to the present disclosure is not limited to thereto. Even if the widths of the titles are different from each other, the benefits of the method in the present disclosure are still be realized. For simplicity, the widths of the titles in the embodiments of the present disclosure are the same. In addition, for each of the titles in the present disclosure, the width of the title may be changed with the content of the title, so that the user may view all the information of the title on screens with different sizes.

In some embodiments, in the window display method according to the present disclosure, in response to moving the page display region 11 in a second direction perpendicular to the first direction, the title display region 12 is not moved. As described above, if the first direction is the horizontal direction or the lateral direction, the second direction is the vertical direction or the longitudinal direction. In a case that the page display region 11 is moved in the second direction, the page display region 11 should display a page corresponding to a current title, thus the title display region 12 is not moved. In some embodiments, by moving the page display region 11 in the second direction, information that has not been displayed may be displayed in the page display region 11.

In some embodiments, the title display region 12 includes a first title (such as, a title 15) corresponding to a page displayed in the page display region 11 and a second title (such as, a title 16) adjacent to the first title. The first title 15 has a first brightness, the second title 16 has a second brightness, and the first brightness is greater than the second brightness. That is, the title, corresponding to the displayed page, in the title display region 12 is highlighted. Thus, the user may intuitively know the title corresponding to the page currently displayed in the page display region 11.

In some embodiments, after the title display region 12 is moved in the first direction by the second distance as described above, the second title (such as, the title 16) in the title display region 12 is moved to the position of the first title 15, then the page display region 11 displays a page corresponding to the second title 16, and the second title is displayed in the title display region 12 and has the first brightness. That is, the second title 16 is highlighted. In some embodiments, after the title display region 12 is moved in the first direction by the second distance, in a case that the second title 16 in the title display region 12 is moved to the position of the first title 15 and the first title 15 is still displayed in the title display region 12, the brightness of the first title 15 is changed from the first brightness to the second brightness. That is, the first title 15 is no longer highlighted. Therefore, the highlighted title corresponds to the page displayed in the page display region 11.

In some embodiments, in a case that the title display region 12 includes few titles, the title display region 12 may display all the titles. In this case, in response to an operation event performed in the page display region 11, the page in the page display region 11 is moved the first distance, the page in the page display region 11 displays the page corresponding to the second title 16, brightness of the first title 15 is changed from the first brightness to the second brightness, and brightness of the second title 16 is changed from the second brightness to the first brightness. It should be understood that in this case, the title in the title display region 12 is not moved, the brightness of the title is changed, and the title corresponding to the page displayed in the page display region 11 is always highlighted. When the page displayed in the page display region 11 is changed, the highlighted title is accordingly changed to a title corresponding to a newly displayed page.

In some embodiments, if a selected title is out of the screen (for example, only half of the selected title is displayed), the title is automatically moved to an adjacent screen region. That is, a title may be slid along a width of the title, so that the title, corresponding to the displayed page and in a selected state, is completely visible, and it is convenient for the user to see the page being operated.

In addition to switching a page displayed in the page display region 11 by sliding the title display region 12, a page may be switched by clicking a displayed title corresponding to the page. For example, after clicking the title, the page display region 11 displays a page corresponding to the title 16.

According to an embodiment of the present disclosure, a window display apparatus 400 corresponding to the method described above is provided. The apparatus includes an application window display module 401 and a control module 402. The application window display module 401 is configured to display an application window, where the application window includes a title display region and a page display region, and the title display region includes a title corresponding to a page displayed in the page display region. The control module 402 is configured to, in response to an operation event performed in the page display region 11 or in the title display region 12, move the page in the page display region by a first distance and move the title in the title display region by a second distance. As one of the page and the title is moved, the other one of the page and the title is also moved, and the first distance is different from the second distance. In some embodiments, the operation event is an operation for sliding a page in the page display region 11 or sliding a title in the title display region 12, including but not limited to a sliding operation, a voice command or a gesture operation. The operation event may be performed in the page display region 11 or in the title display region 12, so that as one of the page in the page display region 11 and the title in the title display region 12 is moved or slid, the other one of the page in the page display region 11 and the title in the title display region 12 is moved or slid accordingly, where the distance by which the page in the page display region 11 is moved is different from the distance by which the title in the title display region 12 is moved.

In some embodiments, the control module is further configured to move the page in a first direction by the first distance and move the title in the first direction by the second distance. The page has a first width in the first direction, the title has a second width in the first direction, and a ratio of the first width to the second width is equal to a ratio of the first distance to the second distance. Thus, linkages between pages displayed in the page display region and titles corresponding to the pages are realized.

According to the present disclosure, a terminal is further provided. The terminal includes at least one memory and at least one processor. The memory stores program codes. The processor is configured to perform, when executing the program codes stored in the memory, the window display method described above.

According to the present disclosure, a computer storage medium is further provided. The computer storage medium stores program codes. The program codes are executed to perform the window display method described above.

In some embodiments, a page displayed in the page display region and a title corresponding to the pages may be linked to each other according to the present disclosure. In addition, the title corresponding to the displayed page is highlighted, so that the user may conveniently know the title corresponding to the displayed page. With the method according to the present disclosure, convenience of page interaction is greatly improved, thereby improving the user experience.

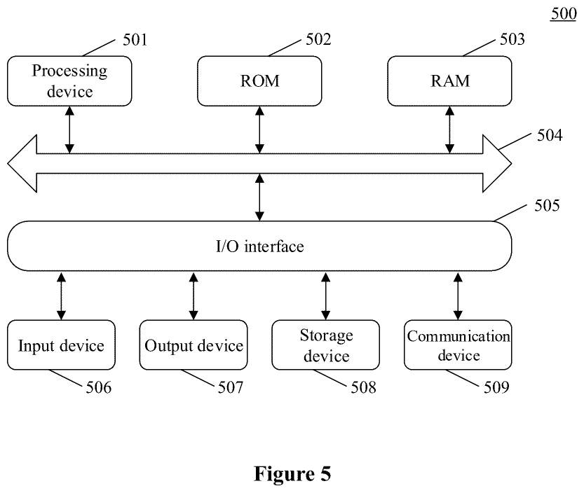

Hereinafter, reference is made to FIG. 5, which shows a schematic structural diagram of an electronic device 500 suitable for implementing the embodiments of the present disclosure. The terminal devices according to the embodiments of the present disclosure may include, but are not limited to, mobile terminals, such as mobile phones, laptops, digital broadcast receivers, PDAs (personal digital assistants), PADs (tablet PCs), PMPs (portable multimedia players), vehicle-mounted terminals (such as in-vehicle navigation terminals) and the like, and fixed terminals such as digital TVs, desktop computers, and the like. The electronic device shown in FIG. 5 is only exemplary, and should not indicate any limitation to the function and application scope of the embodiments of the present disclosure.

As shown in FIG. 5, the electronic device 500 may include a processing device 501 (such as a central processing unit and a graphics processor) which may execute various operations and processing through a program stored in a Read Only Memory (ROM) 502 or a program loaded from the storage device 506 into a Random Access Memory (RAM) 503. The RAM 503 is further configured to store various programs and data required by the electronic device 500. The processing device 501, the ROM 502 and the RAM 503 are connected to each other through a bus 504. An Input/output (I/O) interface 505 is also connected to the bus 504.

Generally, the I/O interface 505 may be connected to: an input device 506, such as a touch screen, a touch panel, a keyboard, a mouse, a camera, a microphone, an accelerometer, and a gyroscope; an output device 507, such as a liquid crystal display (LCD), a speaker, and a vibrator; a storage device 506 such as a magnetic tape and a hard disk; and a communication device 509. The communication device 509 enables the electronic device 500 to perform wireless or wired communication with other devices for data exchanging. Although FIG. 5 shows an electronic device 500 having various components, it should be understood that the illustrated components are not necessarily required to all be implemented or included. Alternatively, more or fewer components may be implemented or included.

Particularly, according to an embodiment of the present disclosure, the process described above in conjunction with flow charts may be implemented as a computer program. For example, a computer program product is further provided in an embodiment in the present disclosure, including a computer program carried on a non-transitory computer readable medium. The computer program includes program codes for performing the method shown in the flow charts. In the embodiment, the computer program may be downloaded and installed from the network via the communication device 509, or installed from the storage device 506, or installed from the ROM 502. When the computer program is executed by the processing device 501, the above-mentioned functions defined in the method according to the embodiments of the present disclosure are performed.

It should be noted that, the computer readable medium mentioned herein may be a computer readable signal medium or a computer readable storage medium or any combination thereof. The computer readable storage medium may be but is not limited to, a system, an apparatus, or a device in an electronic, magnetic, optical, electromagnetic, infrared, or semi-conductive form, or any combination thereof. The computer readable storage medium may be, but is not limited to, an electrical connection with one or more wires, a portable computer disk, a hard disk, a random access memory (RAM), a read-only memory (ROM), an erasable programmable read-only memory (EPROM or flash memory), an optical fiber, a portable compact disc read-only memory (CD-ROM), a light storage device, a magnetic storage device or any combination thereof. In the present disclosure, the computer readable storage medium may be any tangible medium containing or storing a program, and the program may be used by or in combination with an instruction execution system, apparatus, or device. In the embodiment of the present disclosure, the computer readable signal medium may be a data signal transmitted in a baseband or transmitted as a part of a carrier wave and carrying computer readable program codes. The transmitted data signal may be in various forms, including but not limited to an electromagnetic signal, an optical signal or any proper combination thereof. The computer readable signal medium may be any computer readable medium other than the computer readable storage medium and can send, propagate or transmit programs to be used by or with an instruction execution system, apparatus or device. The program codes stored in the computer readable medium may be transmitted via any proper medium including but not limited to: wired, optical fiber cable, radio frequency (RF), or any suitable combination of the foregoing.

In some embodiments, the client and the server may perform communication using any currently known or future developed network protocol such as HTTP (HyperText Transfer Protocol), and may be interconnected with any form or medium of digital data communication (for example, a communication network). The communication network embodiments include local area networks (“LANs”), wide area networks (“WANs”), internet, end-to-end networks (for example, ad hoc end-to-end networks), and any networks currently known or developed in the future.

The computer readable medium may be incorporated in the electronic device, or may exist alone without being assembled into the electronic device.

The computer readable medium carries one or more programs. The one or more programs, when being executed by the electronic device, cause the electronic device to: display at least two internet protocol addresses; transmit a node evaluation request including the at least two internet protocol addresses to a node evaluation device, where the node evaluation device selects an internet protocol address from the at least two internet protocol addresses and return the selected internet protocol address; and receive the internet protocol address returned by the node evaluation device. The displayed internet protocol address indicates an edge node in a content distribution network.

Alternatively, the computer readable medium carries one or more programs. The one or more programs, when being executed by the electronic device, cause the electronic device to: receive a node evaluation request including at least two internet protocol addresses; select an internet protocol address from the at least two internet protocol addresses; and return the selected internet protocol address. The received internet protocol address indicates an edge node in a content distribution network.

Computer program code for performing operations of the present disclosure may be written in one or more programming languages, or a combination of the foregoing, and the programming language includes, but is not limited to, object oriented programming languages, such as Java, Smalltalk, and C++, also includes conventional procedural programming languages, such as “C” language or similar programming languages. The program codes may be executed entirely on a user's computer, or be executed partly on the user's computer, or be executed as a stand-alone software package, or be executed partly on the user's computer and partly on a remote computer, or be executed entirely on the remote computer or server. In a case that the execution of the program code involves a remote computer, the remote computer may be connected to a user's computer via any kind of network, including a local area network (LAN) or a wide area network (WAN), or may be connected to an external computer (for example, via an Internet providing by an Internet service provider).

The flow charts and schematic diagrams in the Figures shows the architecture, functionality and operation of possible implementations of the products of system, method and computer program provided according to the embodiments of the present disclosure. Each block in the flow charts or schematic diagrams can represent a module, a program segment, or a part of code, and the module, the program segment, or the part of code includes one or more executable instructions for implementing specified logical functions. It should be noted that in some alternative implementations, the functions noted in the blocks may be implemented in a different order than those illustrated in the Figures. For example, two blocks shown in succession may in fact be executed substantially in parallel, and they may sometimes be executed in a reverse order, depending upon the functionality involved. It also should be noted that each block in the schematic diagrams and/or flow charts, and combinations of blocks in the schematic diagrams and/or flowcharts, can be implemented by a dedicated hardware-based system which is configured to implement specified functions or operations, or can be implemented by using a combination of dedicated hardware and computer instructions.

The units mentioned in the description of the embodiments of the present disclosure may be implemented by means of software, or otherwise by means of hardware. In some circumstances, the name of a unit does not constitute a limitation on the unit itself. For example, a first display unit may also be described as “a unit that displays at least two internet protocol addresses”.

The functions described above in this application may be performed at least in part by one or more hardware logic components. For example, without limitation, exemplary types of hardware logic components that can be used include: Field Programmable Gate Array (FPGA), Application Specific Integrated Circuit (ASIC), Application Specific Standard Product (ASSP), System on Chip (SOC), Complex Programmable Logical device (CPLD) and so on.

In the present disclosure, a machine-readable medium may be a tangible medium, which may contain or store a program used by the instruction execution system, apparatus, or device or a program used in combination with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of thereof. The machine-readable storage media, for example, includes an electrical connection based on one or more wires, a portable computer disk, a hard drive, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of thereof.

According to one or more embodiments of the present disclosure, a window display method is provided. The method includes: displaying an application window, where the application window includes a title display region and a page display region, and the title display region includes a title corresponding to a page displayed in the page display region; and in response to an operation event performed in the page display region or in the title display region, moving the page in the page display region by a first distance and moving the title in the title display region by a second distance; where as one of the page and the title is moved, the other one of the page and the title is also moved, and the first distance is different from the second distance.

According to one or more embodiments of the present disclosure, the operation event includes an operation for moving the page in the page display region or moving the title in the title display region.

According to one or more embodiments of the present disclosure, the page is moved in a first direction by the first distance, and the title is moved in the first direction by the second distance; the page has a first width in the first direction, and the title has a second width in the first direction; and a ratio of the first width to the second width is equal to a ratio of the first distance to the second distance.

According to one or more embodiments of the present disclosure, the method further includes: not moving the title in response to moving the page in a second direction perpendicular to the first direction.

According to one or more embodiments of the present disclosure, the title is a first title, the title display region further includes a second title, the first title has a first brightness, the second title has a second brightness, and the first brightness is greater than the second brightness.

According to one or more embodiments of the present disclosure, the title is a first title, the title display region further includes a second title, the first title has a first brightness, the second title has a second brightness, and the first brightness is greater than the second brightness; and after the first title is moved in the first direction by the second distance, the page display region displays a page corresponding to the second title, and brightness of the second title is changed from the second brightness to the first brightness.

According to one or more embodiments of the present disclosure, in a case that the first title is still displayed in the title display region after the first title is moved in the first direction by the second distance, brightness of the first title is changed from the first brightness to the second brightness.

According to one or more embodiments of the present disclosure, a window display method is provided. The method includes: displaying an application window, where the application window includes a title display region and a page display region, the title display region includes a first title and a second title, the first title corresponds to a page displayed in the page display region, the first title has a first brightness, the second title has a second brightness, and the first brightness is greater than the second brightness; and in response to an operation event performed in the page display region, moving the page in the page display region by a distance without moving the first title and the second title; where after the page is moved by the distance, the page display region displays a page corresponding to the second title, brightness of the first title is changed from the first brightness to the second brightness, and brightness of the second title is changed from the second brightness to the first brightness.

According to one or more embodiments of the present disclosure, a window display apparatus is provided. The apparatus includes: an application window display module and a control module. The application window display module is configured to display an application window, where the application window includes a title display region and a page display region, and the title display region includes a title corresponding to a page displayed in the page display region. The control module is configured to, in response to an operation event performed in the page display region or in the title display region, move the page in the page display region by a first distance and move the title in the title display region by a second distance. As one of the page and the title is moved, the other one of the page and the title is also moved, and the first distance is different from the second distance.

According to one or more embodiments of the present disclosure, the control module is configured to move the page in a first direction by the first distance and move the title in the first direction by the second distance, where the page has a first width in the first direction, the title has a second width in the first direction, and a ratio of the first width to the second width is equal to a ratio of the first distance to the second distance.

According to one or more embodiments of the present disclosure, a terminal is provided. The terminal includes: at least one memory and at least one processor. The memory stores program codes. The processor is configured to perform, when executing the program codes stored in the memory, the window display methods described above.

According to one or more embodiments of the present disclosure, a computer storage medium is provided. The computer storage medium stores program codes. The program codes are executed to perform the window display methods described above.

The above description includes merely preferred embodiments of the present disclosure and explanations of technical principles used. Those skilled in the art should understand that the scope of the present disclosure is not limited to technical solutions formed by a specific combination of the above technical features, but covers other technical solutions formed by any combination of the above technical features or equivalent features thereof without departing from the concept of the present disclosure. For example, a technical solution formed by interchanging the above features with technical features having similar functions as disclosed (but not limited thereto) is also covered in the scope of the present disclosure.

In addition, although the operations are described in a specific order, it should not be understood that these operations are to be performed in the specific order shown or performed in a sequential order. Under certain circumstances, multitasking and parallel processing may be advantageous. Although the specific implementation details are described above, these implementation details should not be construed as limiting the scope of the present disclosure. The features described in multiple separate embodiments may be implemented in combination in a separate embodiment. Conversely, the features described in a separate embodiment may be implemented in multiple embodiments individually or in any suitable sub-combination.

Although the solutions according to the present disclosure have been described in language specific to structural features and/or logical actions of the method, it should be understood that the solutions defined in the appended claims are unnecessarily limited to the specific features or actions described above. The specific features and actions described above are merely exemplary forms of implementing the claims.

1. A window display method, comprising:
displaying a window of an application installed in a terminal device, wherein the window of the application is divided into a title display region and a page display region, wherein the title display region includes a plurality of titles, the plurality of titles include a first title, and wherein the page display region includes a first page corresponding to the first title;
in response to a sliding event performed on the page display region in a first direction, moving the first page in the first direction by a first distance to display a second page corresponding to a second title, and moving the first title in the first direction by a second distance, wherein a ratio of the first distance to the second distance is determined based on a width of the first page in the first direction and a width of the first title in the first direction;
detecting that the first title is partially displayed or positioned outside a visible region of the title display region after moving the first title by the second distance; and
in response to the detecting, automatically moving the first title so that the first title is completely visible within the title display region.

2. The window display method according to claim 1, wherein the automatically moving the first title comprises: sliding the first title to an adjacent display region within the title display region such that the first title is completely visible.

3. The window display method according to claim 1, wherein in a case that the first page is moved by a distance equal to the width of the first page to display the second page, the first title is moved by a distance equal to the width of the first title, whereby the second title is moved to a position of the first title.

4. The window display method according to claim 1, wherein the first title has a first brightness and the second title has a second brightness lower than the first brightness, and the method further comprises: automatically switching a brightness of the second title from the second brightness to the first brightness in response to the first title being moved by the second distance.

5. The window display method according to claim 1, wherein the first distance is one or more times of the width of the first page, and the second distance is one or more times of the width of the first title.

6. The window display method according to claim 1, further comprising: in response to a sliding event performed on the window in a second direction perpendicular to the first direction, scrolling content within the second page in the second direction while maintaining the plurality of titles in the title display region stationary.

7. The window display method according to claim 1, wherein a width of each of the plurality of titles is variable, and wherein the width of each title is determined based on content displayed in the respective title, and the second distance corresponds to the width of the first title.

8. A window display apparatus, comprising: at least one processor; and at least one memory communicatively coupled to the at least one processor and storing instructions that upon execution by the at least one processor cause the apparatus to perform operations comprising:
displaying a window of an application installed in a terminal device, wherein the window of the application is divided into a title display region and a page display region, wherein the title display region includes a plurality of titles, the plurality of titles include a first title, and wherein the page display region includes a first page corresponding to the first title;
in response to a sliding event performed on the page display region in a first direction, moving the first page in the first direction by a first distance to display a second page corresponding to a second title, and moving the first title in the first direction by a second distance, wherein a ratio of the first distance to the second distance is determined based on a width of the first page in the first direction and a width of the first title in the first direction;
detecting that the first title is partially displayed or positioned outside a visible region of the title display region after moving the first title by the second distance; and
in response to the detecting, automatically moving the first title so that the first title is completely visible within the title display region.

9. The window display apparatus according to claim 8, wherein the automatically moving the first title comprises: sliding the first title to an adjacent display region within the title display region such that the first title is completely visible.

10. The window display apparatus according to claim 8, wherein in a case that the first page is moved by a distance equal to the width of the first page to display the second page, the first title is moved by a distance equal to the width of the first title, whereby the second title is moved to a position of the first title.

11. The window display apparatus according to claim 8, wherein the first title has a first brightness and the second title has a second brightness lower than the first brightness, and the operations further comprise: automatically switching a brightness of the second title from the second brightness to the first brightness in response to the first title being moved by the second distance.

12. The window display apparatus according to claim 8, wherein the first distance is one or more times of the width of the first page, and the second distance is one or more times of the width of the first title.

13. The window display apparatus according to claim 8, the operations further comprising:
in response to a sliding event performed on the window in a second direction perpendicular to the first direction, scrolling content within the second page in the second direction while maintaining the plurality of titles in the title display region stationary.

14. The window display apparatus according to claim 8, wherein a width of each of the plurality of titles is variable, and wherein the width of each title is determined based on content displayed in the respective title, and the second distance corresponds to the width of the first title.

15. A non-transitory computer-readable storage medium, storing program codes, wherein the program codes are executed to perform the window display method according to claim 1.
